(19) United States
(12) Patent Application Publication
(10) Pub. No.: US 2021/0344300 A1
(43) Pub. Date: Nov. 4, 2021

(54) SOLAR CELL FIELD CLEANING APPARATUS

(71) Applicant: GIORA GALILI, KIBBUTZ NAAN (IL)

(72) Inventor: GIORA GALILI, KIBBUTZ NAAN (IL)

(21) Appl. No.: 17/274,201

(22) PCT Filed: Sep. 19, 2019
(86) PCT No.: PCT/IL2019/051038

§ 371 Date: Mar. 8, 2021

Related U.S. Application Data
(60) Provisional application No. 62/733,658, filed on Sep. 20, 2018.

(51) Int. Cl. H02S 40/10; B08B 1/00; B08B 1/04; B08B 3/02

(52) U.S. Cl. CPC H02S 40/10; B08B 3/024; B08B 1/04; B08B 1/008

(57) ABSTRACT

A solar cell field cleaning apparatus (10), including: a chassis (102), for being connected to a vehicle (90); a right horizontal support (42R), for extending right to the chassis (102); a left horizontal support (42L), for extending left to the chassis (102); elongated horizontal cleaning elements (12), being supported by the right (42R) and left (42L) horizontal supports, thereby the solar cell field cleaning apparatus (10) is configured to drive the vehicle (90) between right (92R) and left (92L) solar surfaces, for cleaning thereof by the elongated horizontal cleaning elements (12).

### TECHNICAL FIELD

The invention relates to the field of solar cell cleaning.

### BACKGROUND

One of the means used to produce clean electricity is the P.V. Voltage Power or other types of solar panels for converting solar radiation flux into electricity. Most of the solar panel farms are located in open areas, especially in desert areas. However, the panels are covered with a mask of dust that significantly impairs their electricity output.

The leading panel cleaning method today is with the help of long cleaning wipers operated by simple workers, wiped with a top brush with water wetting and a back rinse with liquid runoff, usually treated water.

A desk robot is limited to the cleaning space. There is a mechanized cleaning approach that requires a large operating team to move the robots from one row to another. This approach is not automated and its economic efficiency is limited.

There are cleaning approaches allowing movement on the solar farm service lines that clean only one row of panels, being as well limited by its economic efficiency.

All known systems clean in an open control circle, which do not allow optimal cleaning adapted to the area conditions, which vary from region to region and period to period significantly.

There is a long felt need to provide a solution to the above-mentioned and other problems of the prior art.

### SUMMARY

A solar cell field cleaning apparatus, including: a right and left horizontal support extending; and elongated horizontal cleaning elements (12), being supported by the horizontal supports.

### BRIEF DESCRIPTION OF THE DRAWINGS

Embodiments, features, and aspects of the invention are described herein in conjunction with the following drawings:

FIG. 1 is a front perspective view of a solar cell field cleaning apparatus according to one embodiment of the invention.

FIG. 2 is a front view of the solar cell field cleaning apparatus 10 of FIG. 1, being connected to a vehicle, while cleaning solar cell surfaces.

FIG. 3 is a perspective front view of the two cleaning elements of FIG. 1 and of a cleaning element suspension, for operating the cleaning elements.

FIG. 4 is a side view of the cleaning element of FIG. 3, while rubbing one of the solar surfaces of FIG. 2.

FIG. 5 describes the height of the cleaning element as a function of a small amount of absorbed water, being at the first step.

FIG. 6 describes the height of the cleaning element as a function of a larger amount of absorbed water, being at the first step.

FIG. 7 depicts a mechanical control of the water dispenser of FIG. 3 while the cleaning element absorbs the small amount of FIG. 5.

FIG. 8 depicts the mechanical control of the water dispenser of FIG. 3 for absorbing the larger amount of FIG. 6.

FIG. 9 depicts the third step of use. FIG. 10 depicts the fourth step of use.

FIG. 11 depicts the fifth and sixth steps of use.

FIG. 12 is the front view of FIG. 2, for depicting one operation of balancing the weight of the left and right horizontal cleaning element supports.

FIG. 13 is the front view of FIG. 2 for depicting another operation of balancing the weight of the left and right horizontal cleaning element supports.

FIG. 14 is the front view of FIG. 2 for depicting another operation of balancing the weight of the left and right horizontal cleaning element supports.

FIG. 15 is a top view of the solar cell field cleaning apparatus 10 of FIG. 1, being connected to the vehicle, for depicting another operation of balancing the weight of the left and right horizontal cleaning element supports.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

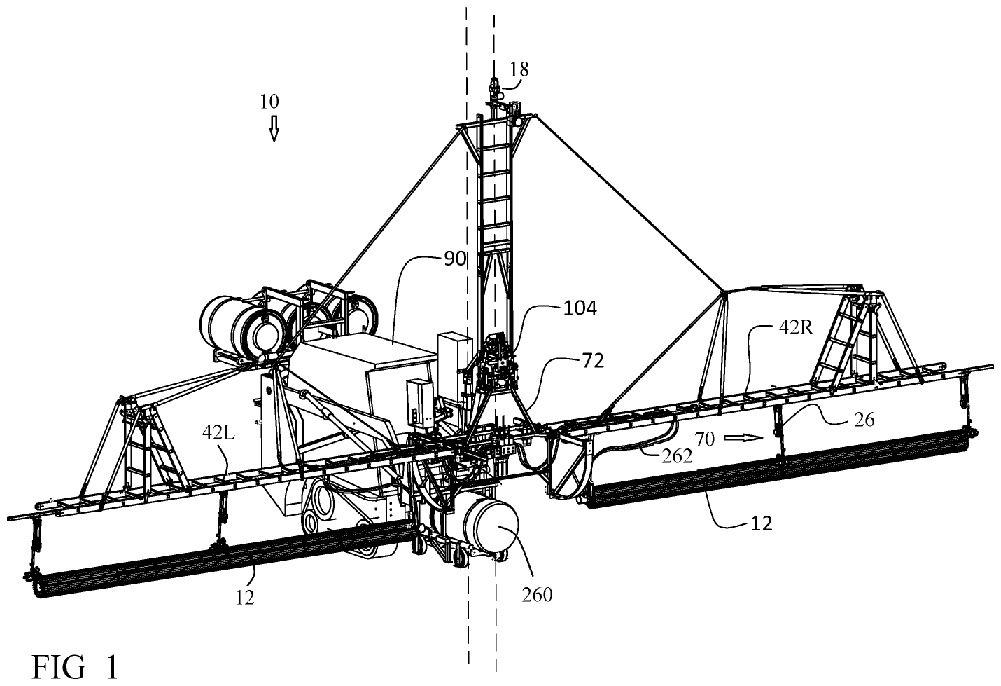

FIG. 1 is a front perspective view of a solar cell field cleaning apparatus according to one embodiment of the invention.

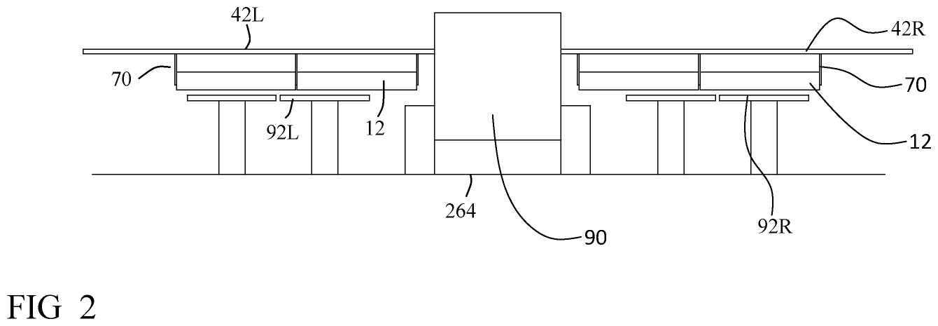

A solar cell field cleaning apparatus 10 according to one embodiment of the invention includes at least one water tank 260, for supplying water through pipes 262 to water dispensers 26, for dispensing water to horizontal cylindrical cleaning elements 12, for cleaning solar cell surfaces (shown in FIG. 2).

Horizontal cleaning elements 12 are hung on a right horizontal cleaning element support 42R and on a left horizontal cleaning element support 42L, via vertical cleaning element suspensions 70, extending from horizontal cleaning element supports 42L and 42R to cleaning elements 12.

FIG. 2 is a front view of the solar cell field cleaning apparatus 10 of FIG. 1, being connected to a vehicle, while cleaning solar cell surfaces.

The term “vehicle” refers herein to a land vehicle, such as a skid-steer loader, and may refer to an aircraft vehicle, such as a quadocopter.

Solar cell field cleaning apparatus 10 is configured to connect thereto a vehicle 90 between right horizontal support 42R and left horizontal support 42L, for riding vehicle 90 along a path 264 between a right solar surface 92R and a left solar surface 92L, for transporting cleaning elements 12 adjacent thereto for cleaning thereof.

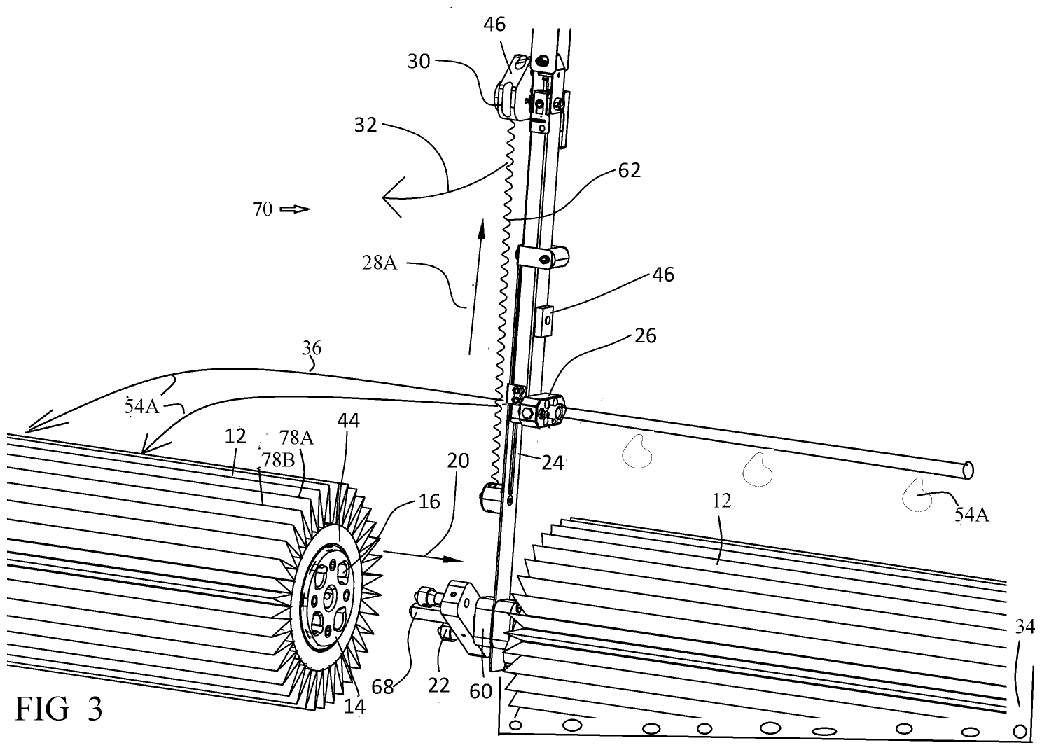

FIG. 3 is a perspective front view of the two cleaning elements of FIG. 1 and of a cleaning element suspension, for operating the cleaning elements.

Cleaning element suspension 70 is configured to be disposed between two cleaning elements 12, for rotating them by a motor 60. Cleaning element suspension 70 includes a water dispenser 26, for dispensing water to cleaning elements 12.

Cleaning element 12 constitutes a sponge, being shaped to include a plurality of triangular horizontally elongated teeth 78A, 78B, etc.

Water 54A is dispensed from water dispenser 26 onto cleaning element 12, from above cleaning element 12, or by immersion in a compartment 34, or splashed.

FIG. 4 is a side view of the cleaning element of FIG. 3, while rubbing one of the solar surfaces of FIG. 2.

Water 54A is dispensed from water dispenser 26 onto cleaning element 12, from above cleaning element 12, or by immersion or in another way. Cleaning element 12 rotates 52 and linearly advances 58 at a height characterized to slightly squeeze bottom tooth 78C in relation to non-squeezed tooth 78A, for squeezing a bit of water 54C.

However, most of the space of teeth 78A,78B,78C, etc.

normally includes air, rather than water 54B during the rubbing, thus cleaning element 12 is lightweight. Thus, teeth 78D and 78E normally rub previously dispensed water, thus producing a thin water layer 86, thus not spilling water, thus reducing amount of water required for the cleaning.

Referring again to FIG. 3, cleaning element suspension 70 includes a telescopic rod 24 and a vertical spring 62 for lifting 28A of cleaning elements 12 against the weight thereof, being a function of the amount of water absorbed by cleaning elements 12, to a certain height.

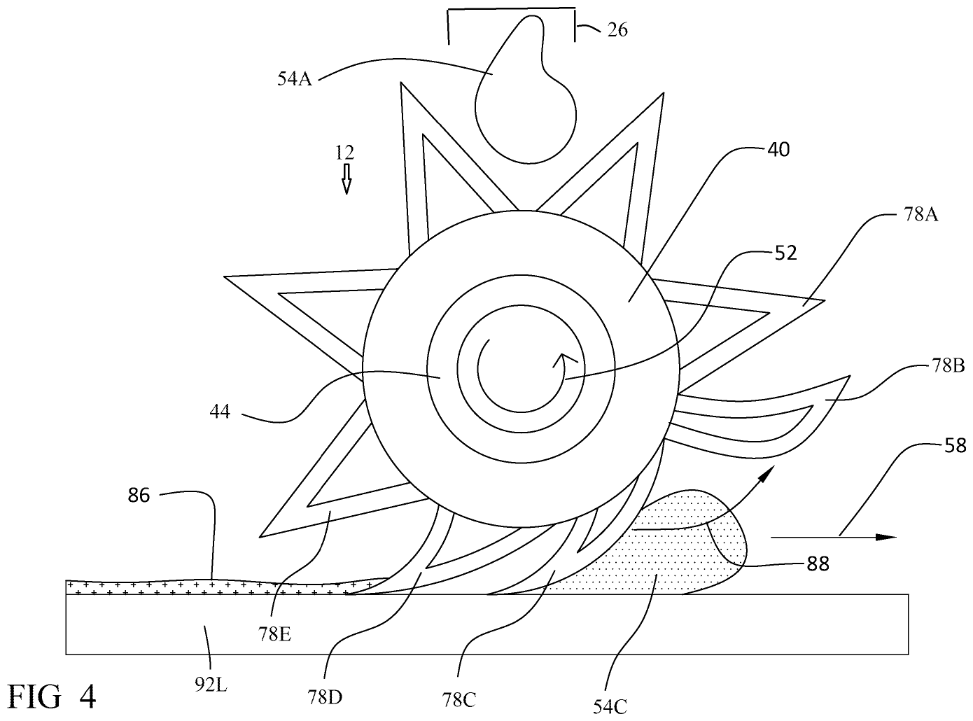

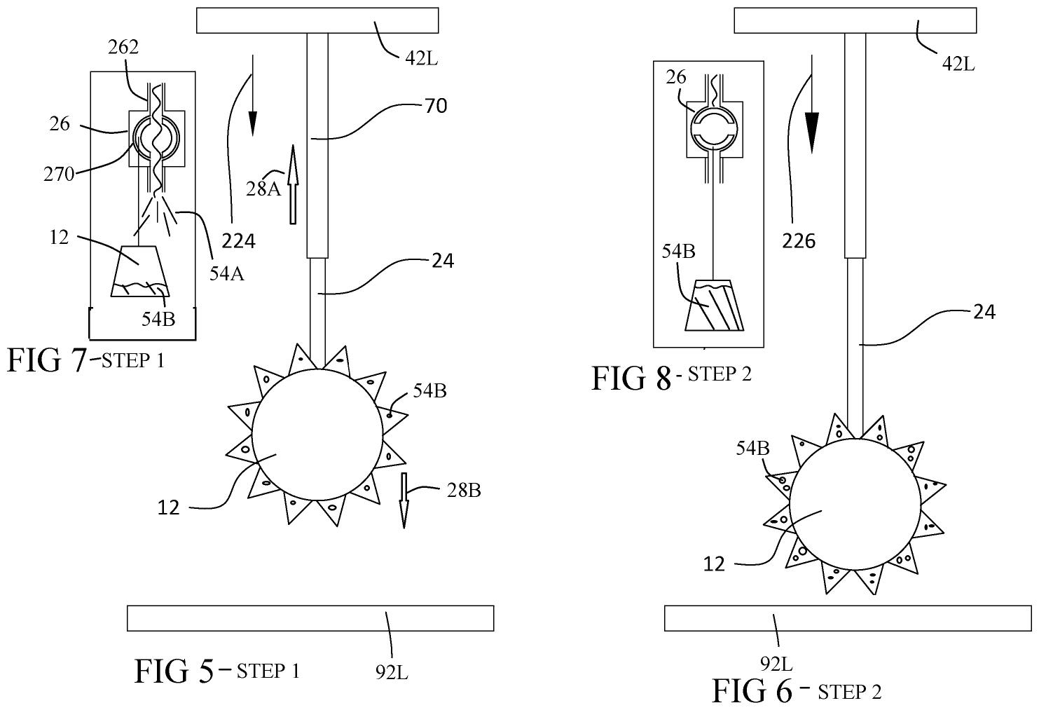

FIG. 5 describes the height of the cleaning element as a function of a small amount of absorbed water, being at the first step.

FIG. 6 describes the height of the cleaning element as a function of a larger amount of absorbed water, being at the first step.

The height of cleaning element 12 in relation to left solar surface 92L is a balance of lifting force 28 of spring 62 and gravity force 28B being a function of the amount of water 54B absorbed in cleaning element 12.

Thus, cleaning element 12 of FIG. 5 absorbing a small amount of water 54B at the first step is disposed higher than cleaning element 12 of FIG. 6 at the second step of receiving and absorbing a larger amount of water 54B.

FIG. 7 depicts a mechanical control of the water dispenser of FIG. 3 while the cleaning element absorbs the small amount of FIG. 5.

FIG. 8 depicts the mechanical control of the water dispenser of FIG. 3 for absorbing the larger amount of FIG. 6.

Water dispenser 26 is mechanically connected to cleaning element 12 for being controlled by gravity force 28B of cleaning element 12. For example, water dispenser 26 constitutes a water valve, the lever 270 thereof for being pulled by cleaning element 12.

While cleaning element 12 absorbs the small amount is thus disposed high, the small weight thereof is not sufficient to close water valve 26, thus dispensing water 54A to cleaning element 12, thus descending cleaning element 12, until closing water valve 26.

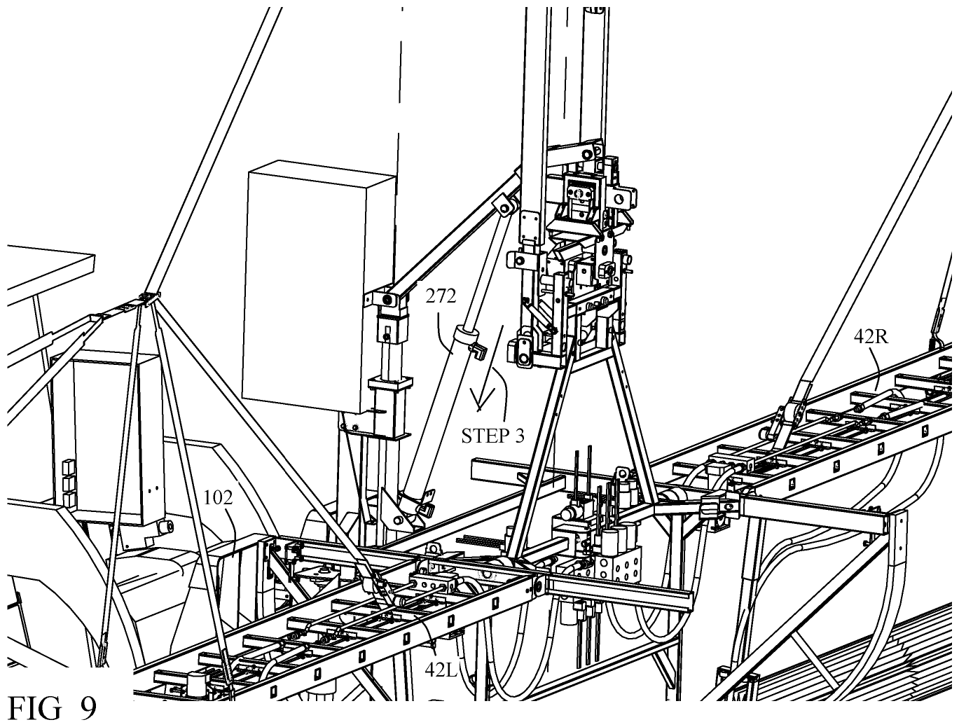

FIG. 9 depicts the third step of use.

At the third step, a hydraulic cylinder 272 lowers right horizontal cleaning element support 42R and left horizontal cleaning element support 42L.

FIG. 10 depicts the fourth step of use.

Cleaning element suspension 70 includes a vertical rod, being freely rotatable about a hinge 240 in relation to horizontal cleaning element support 42L, thus cleaning element 12 freely falls on solar surface 92L, i.e., by gravity only, thus the pressing is similar to hovering. However, suspension 70 reduces the gravity force.

For example, at the fourth step, being induced by the descending of the third step, cleaning element suspension 70 slightly rotates to an angle 240A, being slightly smaller than 90 degrees from horizontal cleaning element support 42L.

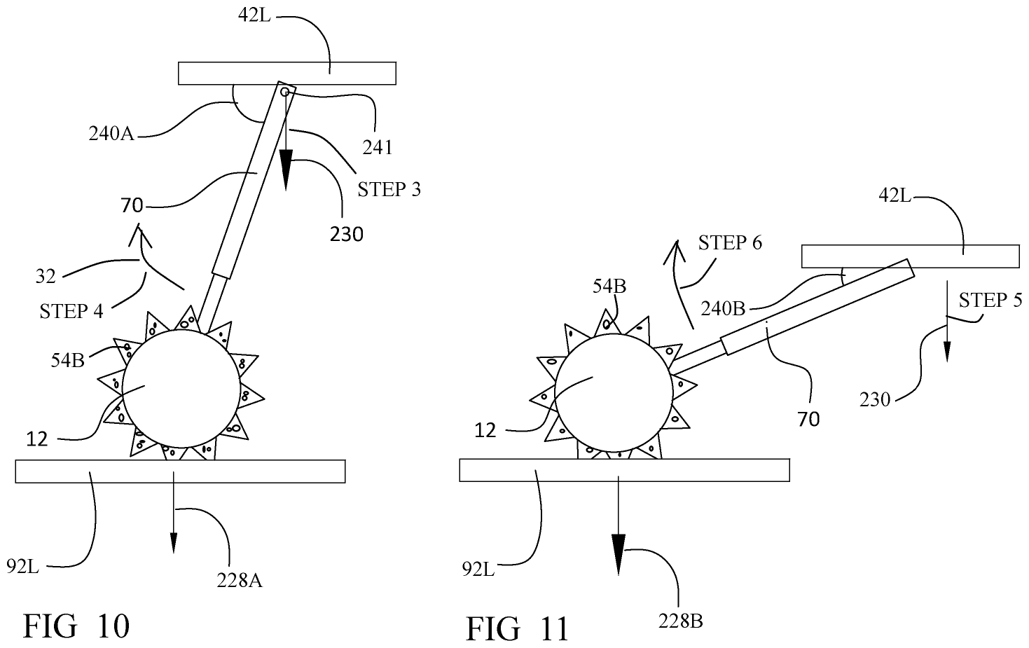

FIG. 11 depicts the fifth and sixth steps of use.

At the fifth step, being induced from removal by squeezing absorbed water 54B from cleaning element 12, horizontal cleaning element support 42L further descends. Thus, at the sixth step, being induced by the further descending of the fifth step, cleaning element suspension 70 further rotates to an angle 240B, being further smaller than 90 degrees from horizontal cleaning element support 42L.

In contrast to the state of FIG. 10, of which most of the weight of cleaning element 12 is not loaded on solar surface 92L due to the suspending, at the state of FIG. 11, most of the weight of cleaning element 12 indeed is loaded on solar surface 92L.

However, at the state of FIG. 10 cleaning element 12 is heavier due to absorbing more water than in FIG. 11. Thus, cleaning element 12 applies an equal load in FIG. 10 and FIG. 11, due to compensation of angle 240B to the weight of water 54B.

Preferably, and as depicted in FIG. 2, vehicle 90 should drive symmetrically between the right and left solar surfaces.

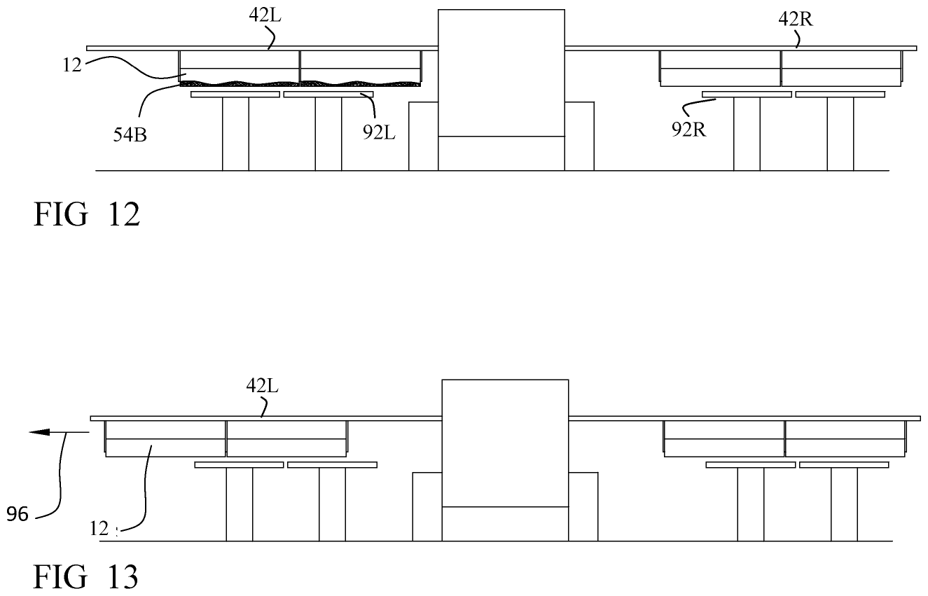

FIG. 12 is the front view of FIG. 2, for depicting one operation of balancing the weight of the left and right horizontal cleaning element supports.

However, the driving path does not always allows the balancing, such as shown in FIG. 12, in which right solar surface 92R is farther than vehicle 90, in relation to left solar surface 92L, and thus cleaning element 12 of solar surface 92R applies a larger gravity force.

One solution for maintaining the balance is to make cleaning element 12 heavier, for supplying excess of water to absorb.

The balancing is essential, as vehicle 90 is very small in relation to cleaning elements 12.

FIG. 13 is the front view of FIG. 2 for depicting another operation of balancing the weight of the left and right horizontal cleaning element supports.

Another solution for maintaining the balance is to slide (96) cleaning element 12 of solar surface 92L away from the center in relation to solar surface 92L, thereby increasing the lever force of cleaning element 12.

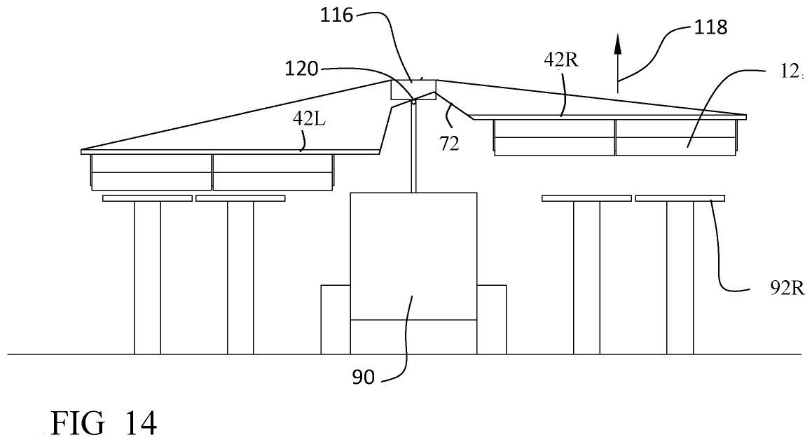

FIG. 14 is the front view of FIG. 2 for depicting another operation of balancing the weight of the left and right horizontal cleaning element supports.

Another solution for maintaining the balance is by vertically rotating the support 72 of right horizontal cleaning element support 42R and of left horizontal cleaning element support 42L by a motor 116.

However, this will lift (118) right horizontal cleaning element support 42R in relation to left horizontal cleaning element support 42L, while maintaining the states of both to be horizontal.

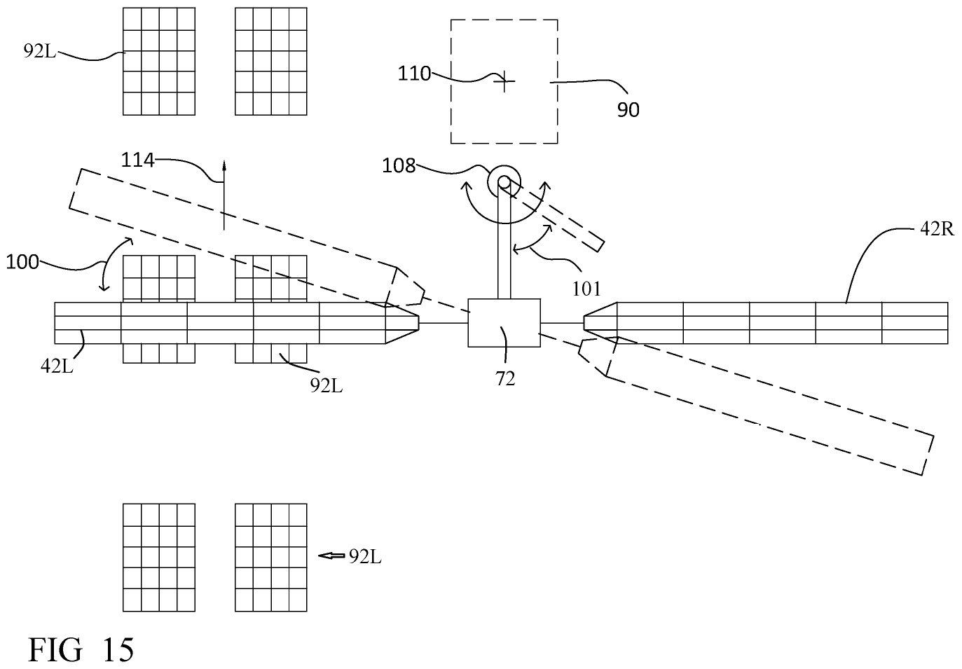

FIG. 15 is a top view of the solar cell field cleaning apparatus 10 of FIG. 1, being connected to the vehicle, for depicting another operation of balancing the weight of the left and right horizontal cleaning element supports.

In case there are present only left solar surfaces 92L to be cleaned, left solar surfaces 92L only horizontally apply friction force 114 on cleaning element 12 (not shown) of left horizontal cleaning element support 42L, thereby rotating it (100) horizontally. A horizontal motor 108 may horizontally rotate (101) for cancelling this horizontal rotating.

Thus, the present invention relates to a floating cleaning wing horizontally to the ground, in a pressurized and controlled armrest across the panels, including: cleaning wipers from non-woven fabric or paper with high absorbency and high mechanical strength.

The wipers dynamically contact the panels, for running a cleaning (work) process for continuous (cyclic) active removal of the dust and other severe impurities from the panels.

In the process of cleaning a series of necessary actions, for optimal and fast cleaning in forward or backward movement:

1. Removal of coarse dust by ‘front wipers’.

2. Front wetting of the dust, by pushing a water wave to the front of the wipers, in preparation for controlled brushing with computerized control of the weight of the drum with water/liquid lubrication.

3. Easy brushing according to the ‘front wiper cleaners’ flexibility.

4. a main brushing, by loading all or part of the drum weight on the ‘central cleaning wipers’, at the bottom of the cleaning drum.

5. Wiping the water by attaching the wipers with a flexible sponge on the panels.

6. Wiping the water and/or solution by “back wipers” in relation to the robot's progress, forward or backward.

7. Absorb the drum in a controlled manner to achieve the desired and optimal weight, by spraying or dripping from the top of the solution/water onto the “top mops” of the drum.

The cleaning wipers lean on a spongy bed. Used as a shock absorber to achieve continuous and continuous (cyclic) high quality coupling of the wipers on the panel surface, with a large contact area: long and wide, achieved by the wiper body.

The cleaning drum core on which is fitted with a ‘spongy substrate roll’, transmits the torque from the core to the wipers.

The drum core transmits torque throughout the drum/wing.

Torque transfer is accomplished by connecting several drum sections with friction connectors (to the conveying stage).

The drum flexibility is achieved by selecting the appropriate drum core material (thin-walled tube).

The drum core is based on a thin-walled tube, such as plastic and/or condenser polymers, with physical properties suitable for self-immersion, adapted to absorb corrugated aberrations resulting from the uneven and curvature panels and the ground surface on which the sun absorption devices are installed.

“Wiper strip” structure, in the initial state—is geometrically shape as accordion triangles.

The wipers change their geometric shape to full flush mode, according to the pressure applied to them by the wipers soaked in the liquid.

For operational maintenance, the cleaning wiper roll is closed with a zipper or other latch, which allows for maintenance on the ground after grinding or wear of the cleaning tooth roller.

The weight of the drum is determined by the duration of the splash or drip of water from the top or sides of the wipers. The impregnation process stopped with the shaking valve closed. Replacement (self-weight water-free drum buoyancy) is performed by a ‘spring recoil’ that closes the ‘shake valve’ when the drum weight reaches a suitable weight for optimal cleaning performance, depending on the thickness of the mask on the panels.

A pair of water valves on the wing carrier or rear fork water system are closed electronically, where no “wiper cleaners” (such as the panel cleaning phase) are required or for forced wing balancing.

The drums are driven, for example, by hydraulic and/or electric motors.

The drums depend on ‘telescoping snapshots’, which have a large range of motion and an electromechanical distance reading based on the swiping contact of the wipers on the panels while the contact of wipers cleaning on the panel surfaces.

Reading the tow angle on the jaws with respect to the wing (trusses) above, precisely defines the height of the drum axis with respect to the “wing flanges” and the weight of the work loaded on the panels. This indicator allows determining the duration of the cleaning, the length of the cleaning wipers and the intensity of the work =pressure (area X weight) applied for optimal cleaning.

The cleaning wing is balanced as a swing. Built from a pair of lightweight trusses (such as aluminum scales), allowing the wing to balance with a loose hang on a wing carrier mast, by utilizing both sides of the wing for balance. This mechanical mechanism allows for a strong, wide wing operation according to the different needs of the solar farm. Exceptions exert “balancing” facility forces.

The wipers are mainly built nunwoven (alone) with small holes (fire). They have the ability to filter and accumulate macaroni dust. Suitable for rough dirt cleaning, as well as panel polishing and removal of accumulated scrapes over several years, as a result of storms and extreme weather conditions in deserts.

In the upper telescopic jaw axis is an incubator/potentiometer or an acronym on the jib arm. Emotions such as this are used to read the ‘tilt angle’ with respect to the wing truss, this ability allows accurate calculation of the ‘pivot axis’ height from the panel plane continuously, during contact with them and dragging the drum back by cleaning wipers.

A wing balancing mechanism located in the center, on the edge of the “Sift-mast”. This mechanism allows for weight compensation in asymmetrical cleaning mode. Like an uneven squeeze of the cleaning fluid between the two sides of the wing in the XY plane.

The balancing mechanism also allows the pressing force against the heavier monitor with an engine. Thus, allowing the wing parallel to the ground, to be deliberately maintained. The balancing mechanism also includes a ‘detach curve’ for emergency stop, being enabled once one of the wing sides encounters an unexpected obstacle, for twisting around the ZX plane at the alpha angle.

Extreme drag torque on the wing is activated on the balance on the alpha axis to apply the touch of detachment emotion to be detached in the balance, operating an emergency stop command for a mobile device.

Variable drag compensation: An the center of the bearing on the “wing mast axis” in the ZX plane—beta angle, is located a hydraulic or electric motor, allowing analog torque compensation when the drag force is not symmetrical between the right and left sides.

A Balance Detachment Curve includes an immediate stop to prevent wing breakage or damage to the panels.

A pivot motor compensates for torque differences and the tow torque has contributed to the disconnection.

In the figures and/or description herein, the following reference numerals (Reference Signs List) have been mentioned:
numeral 10 denotes the solar cell field cleaning apparatus according to one embodiment of the invention;
12: cleaning element;
14: driving disc;
16: driving depression;
18: sensor, such as a radar, for determining distance from solar surfaces 92L,92R;
22: driving pins;
24: telescopic rod;
26: water dispenser, for making cleaning element 12 absorb the water;
28A: lifting;
28B: gravity force;
32: vertical rotation (pitch) of cleaning element suspension;
34: compartment containing water for immersing cleaning element 12;
36: water splashing
40: motion transfer layer;
42L,42R: horizontal supports;
44: cleaning element elongated core;
46: sensor for measuring angle 32 of cleaning element suspension;
52: rotation;
54A: dispensed water;
54B: absorbed water;
54C: squeezed water;
58: advancement by vehicle 90;
60: motor;
62: spring;
68: driving axle;
70: cleaning element suspension being disposed vertical by default, and may be freely vertically rotatable;
72: support of cleaning element supports 42R,42R;
78A,78B,78C,78D,78E: cleaning teeth;
86: water layer;
88: cleaning energy;
90: vehicle or any mobilizing apparatus;
92L,92R: solar surfaces;
96: sliding of cleaning element 12 in relation to horizontal support 42L;
100: horizontal rotation;
101: horizontal rotation;
102: chassis;
108: motor;
110: center of mass of vehicle 90
114: friction force;
116: motor;
118: lifting
120: hinge;

104: rotating apparatus for rotating support 72;
228A,228B: gravity force applied on solar surface 92L;
230: gravity force applied on horizontal support 42L;
240A,240B: angle of vertical suspension 70;
241: hinge;
260: water tank;
262: water pipe;
264: path between solar surfaces 92,92R;
270: lever;
272: hydraulic pump;

The foregoing description and illustrations of the embodiments of the invention have been presented for the purpose of illustration, and are not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1-9. (canceled)

10. A solar cell field cleaning apparatus (10), comprising:
a balanced horizontal support (42R,42L), for being connected to a mobilizing apparatus (90) for being transported thereby; and
elongated cleaning elements (12), being supported by said balanced horizontal support (42R,42L), for being disposed above solar surfaces (92R,92L) for cleaning thereof by touching thereof via controlled height disposition of said elongated cleaning elements (12).

11. The solar cell field cleaning apparatus (10) according to claim 10, further comprising:
a chassis (102), for being connected to said mobilizing apparatus (90), wherein said balanced horizontal support (42R,42L) comprises:
a right horizontal support (42R), for extending right to said chassis (102); and
a left horizontal support (42L), for extending left to said chassis (102), thereby said solar cell field cleaning apparatus (10) is configured to drive said mobilizing apparatus (90) between right (92R) and left (92L) solar surfaces, for cleaning thereof by said elongated cleaning elements (12).

12. The solar cell field cleaning apparatus (10) according to claim 10, wherein said cleaning by said elongated cleaning elements (12) comprises rotating (52) said elongated cleaning elements (12) about itself, while applying gravity forces thereof on said solar surfaces (92L,92R).

13. The solar cell field cleaning apparatus (10) according to claim 10, wherein said supporting of said elongated cleaning elements (12) by said balanced horizontal support (42R,42L) comprises free vertically rotatable (32) suspensions (70), thereby each state (240A,240B) of said vertically rotating of said suspensions (70) determines a portion of gravity force of said elongated cleaning elements (12) being applied on said solar surfaces (92L,92R).

14. The solar cell field cleaning apparatus (10) according to claim 10, wherein each of said elongated cleaning elements (12) comprises a sponge, for absorbing water (54B), for squeezing the water while cleaning said solar surfaces (92L,92R) and producing a thin water layer (86) thereon.

15. The solar cell field cleaning apparatus (10) according to claim 10, wherein each of said elongated cleaning elements (12) comprises a plurality of triangular elongated teeth (78A,78B), thereby each of said teeth (78A,78B) is squeezable separately.

16. The solar cell field cleaning apparatus (10) according to claim 10, further comprising water dispensers (26), for absorbing water into said elongated cleaning elements (12) as a function of weight thereof.

17. The solar cell field cleaning apparatus (10) according to claim 11, further comprising at least one balancing mechanism for balancing gravity force of said elongated cleaning elements (12) applied on said solar surfaces (92L,92R), said at least one balancing mechanism selected from a function group consisting of:
balancing gravity force of each of said elongated cleaning elements (12) for providing hovering;
balancing gravity force between said elongated cleaning elements (12) of said right horizontal support (42R) and of said left horizontal support (42L).

18. The solar cell field cleaning apparatus (10) according to claim 11, further comprising at least one balancing mechanism for balancing gravity force of said elongated cleaning elements (12) applied on said solar surfaces (92L,92R), said at least one balancing mechanism selected from an operation group consisting of:
determining amount of water absorbed in said elongated cleaning elements (12);
determining extent of sliding said elongated cleaning elements (12) away from said chassis (102);
determining extent of height of said elongated cleaning elements (12) in relation to said chassis (102);
determining extent of rotation (102) of said elongated cleaning elements (12) in relation to said chassis (102).

19. The solar cell field cleaning apparatus (10) according to claim 10, wherein said mobilizing apparatus (90) comprises a member selected from a group consisting of: a land vehicle, a skid-steer loader, an aircraft vehicle, a quadocopter.
